(19) United States
(12) Patent Application Publication
(10) Pub. No.: US 2004/0052531 A1
(43) Pub. Date: Mar. 18, 2004

(54) Data to infrared isolated interface device

(76) Inventor: James R. Engler, Depew, NY (US)

Correspondence Address: Kevin D. McCarthy, Hodgson Russ LLP, One M&T Plaza, Suite 2000, Buffalo, NY, 14203-2391, US

(21) Appl. No.: 10/242,950

(22) Filed: Sep. 13, 2002

(51) Int. Cl. H04B 10/00

(52) U.S. Cl. 398/106

(57) ABSTRACT

The present invention is directed to converting a non-hospital-ready electronic device into a hospital-ready electronic device. The invention requires (1) a non-hospital-ready electronic device having an infrared remote control system that receives an infrared signal through a window; (2) a pillow speaker that generates in response to a user's input a first data signal to alter the operation of the non-hospital-ready electronic device; and (3) a data to infrared isolated interface device. The interface device receives the first data signal, and isolates the non-hospital-ready electronic device from the pillow speaker through a phototdiode and a photosensitive transistor. The photosensitive transistor generates a second data signal that corresponds to the first data signal and is generated in response to the first data signal contacting the photodiode. The second data signal is directed to an infrared emitter that is positioned near the window and generates an infrared signal that corresponds to the second data signal. The infrared signal is transmitted into the window which allows the non-hospital-ready electronic device to be controlled by the user through the pillow speaker.

### FIELD OF THE INVENTION

The present invention is directed to converting any non-hospital-ready electronic device to a hospital-ready device. The term “hospital-ready” does not in any way limit the application of this invention to just electronic devices used in hospitals. This invention can be used in any environment, including and not limited to hospitals, nursing homes, homes, apartments, prisons, offices, stores, restaurants, or any other possible environment that electronic devices are used.

### BACKGROUND OF THE INVENTION

It is well known that electronic devices like televisions, computers and radios can be controlled by remote control devices that transmit infrared (“IR”) signals. In many cases, such electronic devices and remote control units are used by everyday consumers. These devices, however, cannot be used in all environments because there are some environments that should be free of IR signals being transmitted across a room (“IR Free Environments”). Reasons for having IR Free Environments include and are not limited to: the IR signal could be deleterious to (1) the user of the remote control unit, (2) other individuals in the room or nearby rooms, and (3) the proper operation of equipment located in the room or nearby rooms.

Some manufacturers have recognized this problem and manufacture electronic devices having a pillow speaker adaptation. These devices are disclosed in the following U.S. Pat. No. 4,398,178 to Russe et al., U.S. Pat. No. 4,549,179 to Steadarde, U.S. Pat. No. 4,862,159 to Marwa et al., U.S. Pat. No. 5,175,441 to den Hollander; U.S. Pat. No. 5,422,631 to Gertz; and U.S. Pat. No. 5,495,301 to Mudra, which are all hereby incorporated by reference.

In particular, Mudra discloses that hospital-ready devices “are wired, i.e. connected by a multi wire cable, to a remotely located control unit that generally incorporates a small so-called pillow speaker. The most rudimentary systems involve three interconnecting wires [data wire, ground wire and audio wire] and include a simple push button (key closure) for stepping the television receiver tuner sequentially through a plurality of television channels with one of the channel positions constituting an on/off position for the television receiver. The pillow speaker usually includes a simple variable resistor for controlling the volume of the sound produced. Such systems consist essentially of a push button switch and an audio volume control. More elaborate systems may incorporate a greater number of wires, generally five, and may provide for channel up, channel down and separate on/off controls. They also have push button key closures for operating the channel controller and include a volume controllable pillow speaker.” When such electronic devices are able to be wired directly to a pillow speaker, they are referred to as hospital-ready devices.

With a conventional pillow speaker, the user presses a button to, for example, change the television channel, radio station, web site page, or the volume of the device. Once the desired button is depressed, the conventional pillow speaker transmits a data signal through the data wire that is directly connected to the television. The television is then controlled by not transmitting an IR signal across the room. As for the volume, the television transmits the sound through the audio wire to the speaker in the pillow speaker.

Unfortunately, some manufacturers have not made such adaptations and such electronic devices are known as non-hospital-ready devices. Some electronic devices can be operated manually and/or through conventional IR receiver components, which are known to those of ordinary skill in the art. For the remainder of this application the term “non-hospital-ready device” refers to electronic devices having IR receiving components. In some instances, non-hospital-ready devices provide superior properties, i.e., sound, graphics, visual and/or size dimensions (flat screen televisions for example), that are desired for IR-free environments. Accordingly, there is a need to convert non-hospital-ready devices into hospital-ready devices for IR-free environments.

### SUMMARY OF THE INVENTION

The present invention is directed to converting a non-hospital-ready electronic device into a hospital-ready electronic device. The invention requires (1) a non-hospital-ready electronic device having an infrared remote control system that receives an infrared signal through a window; (2) a pillow speaker that generates in response to a user's input a first data signal to alter the operation of the non-hospital-ready electronic device; and (3) a data to infrared isolated interface device. The interface device receives the first data signal, and isolates the non-hospital-ready electronic device from the pillow speaker through a photodiode and a photosensitive transistor. The photosensitive transistor generates a second data signal that corresponds to the first data signal and is generated in response to the first data signal contacting the photodiode. The second data signal is directed to an infrared emitter that is positioned near the window and generates an infrared signal that corresponds to the second data signal. The infrared signal is transmitted into the window which allows the non-hospital-ready electronic device to be controlled by the user through the pillow speaker.

### BRIEF DESCRIPTION OF FIGURES

FIG. 1 illustrates a schematic of the present invention.

FIG. 2 illustrates an alternative embodiment of placing the infrared emitter near the infrared window.

FIG. 3 is an alternative embodiment of the present invention of FIG. 1.

### DETAILED DESCRIPTION OF THE PRESENT INVENTION

The present invention 10 is directed to converting a non-hospital-ready device for at least an IR-free environment through a data to IR isolated interface device (“DIRD”) 50.

Applicant admits that a non-hospital-ready device 12 and a conventional pillow speaker 20 are prior art, and are not claiming any rights to such devices.

Applicant, however, will describe the critical elements of the non-hospital-ready device 12 and the coa range of 1-3 hours. By means of conducting heat treatment, it is possible to produce an α″ crystalline phase (Fe₁₆N₂) and to further increase the saturation.

By providing a layered structure of α-Fe and iron nitride in the magnetic thin film in accordance with the present invention, it is possible to reduce the coercive force.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

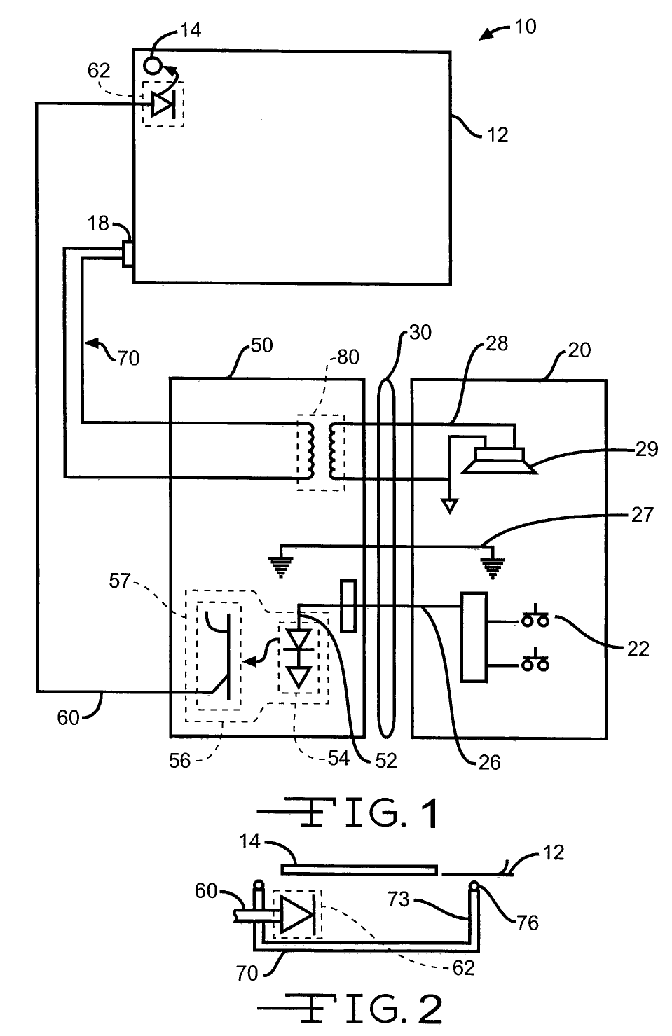

FIG. 1 is a graph showing the relationship between the X-ray diffraction pattern of the iron nitride thin film after film formation, and the flow rate ratio of the N₂ gas during film formation.

FIG. 2 is a graph showing the X-ray diffraction pattern of the iron nitride thin film after heat treatment.

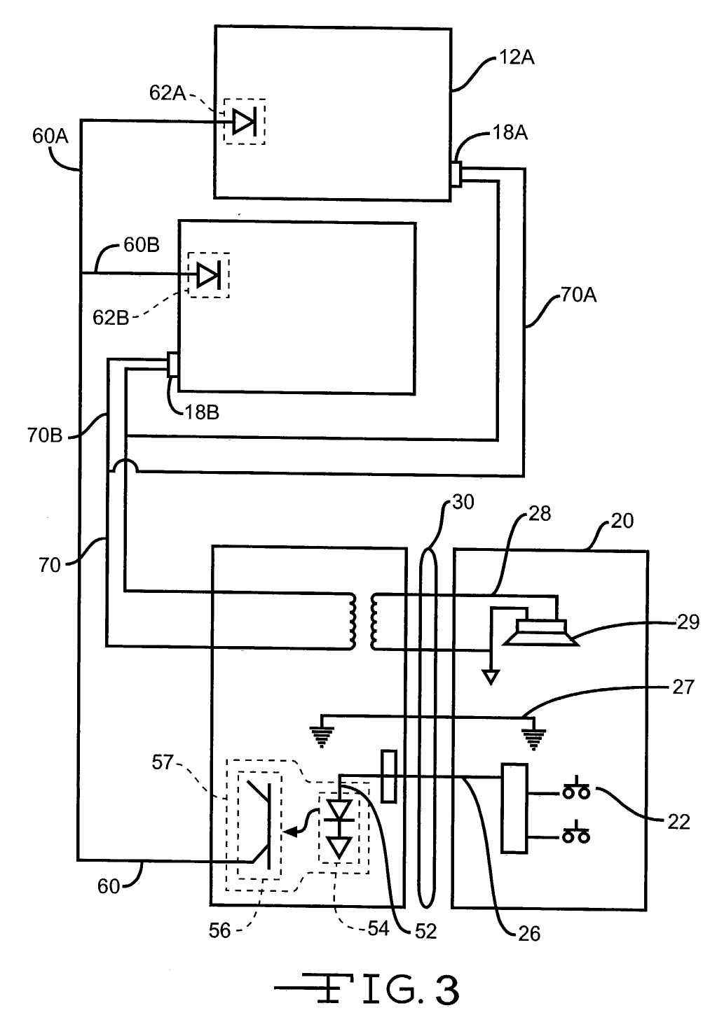

FIG. 3 is a graph showing the changes in the X-ray diffraction pattern of the iron nitride thin film immediately after film formation and after heat treatment.

FIG. 4 is a graph showing the relationship between the amount of N contained in the α″ and α′ phases, and the flow rate ratio of the N₂ gas during film formation.

Corresponding reference characters indin appropriate attendant. In addition, when a user operates the controls 22, the pillow speaker 20 through conventional switches and relays generates a data signal. The data signal is transmitted through a data wire 26, found in a conduit 30. The conduit 30 also contains an audio wire 28 and, optionally, a ground wire 27. The audio wire 28 normally carries an audio signal from the hospital-ready device to a speaker 29 in the pillow speaker 20, which operates as set forth above.

The present invention 10, however, is directed to converting a non-hospital-ready device 12 into a hospital ready device through the DIRD 50. The DIRD 50 is an apparatus that is positioned between the non-hospital-ready device 12 and the pillow speaker 20. In one preferred embodiment, the DIRD 50 is positioned on the side of the device 12 opposite the window 14.

In particular, the DIRD 50 receives the conduit 30, which includes the data wire 26 and the audio wire 28. The data wire 26 has a terminal end 52 within the DIRD 50 that contacts a photodiode 54. The photodiode 54 emits a light signal after the user initiates the pillow speaker 20 to transmit a data signal through the data wire 26.

The DIRD 50 also has a photosensitive transistor 56 that corresponds with the photodiode 54. When the photodiode 54 emits the light signal, the transistor 56 reads the light signal and generates a second data signal, which corresponds with the data signal. The transistor 56 and the photodiode 54 can be obtained in a pre-packaged unit 57. The second data signal is transmitted through an operation wire 60 which has a terminal end connected to a LED device 62.

When the second data signal contacts the LED device 62, the LED device 62 generates an IR signal. The IR signal corresponds with the user input of the pillow speaker 20, i.e., alter the display or volume of the non-hospital-ready device 12.

The LED device 62 is positioned at least in close proximity to the device 12, to allow the IR signal to be transmitted, over a very short distance (an optical isolation), and directed into the IR receiver window 14. Once the signal is through the window 14, the device 12 operates as intended and designed, as set forth above.

Preferably, the LED device 62 is attached to the device 12 and positioned over the window 14. In one embodiment, an adhesive, a hook and loop system, screws, bolts, and any other conventional attachment system (shown in FIG. 2 as element 76) attaches the LED device 62 directly to the device 12. In another embodiment as shown in FIG. 2, a container 70 is attached to the device 10 in the same manner as set forth above, has at least one open end 73 that is positioned over the window 14 and receives the LED device 62 so the LED device 62 is positioned over the window 14.

Extending from the audio output 18 is an output wire 70 that transmits the audio signal from the device 12 to the DIRD 50. Within the DIRD 50, the audio signal is sent through a transformer isolator 80 to the audio wire 28 wherein the audio signal is amplified in the DIRD 50 and then forwarded to the speaker 29.

In each instance, the device 12 and the pillow speaker 20 are isolated from each other.

By using the DIRD 50, the device 12 becomes a hospital-ready device.

Alternatively, the DIRD 50 can be used with a plurality of electronic devices. The electronic devices can be televisions, radios, computers, web site management, VCRs, DVDS, video games, cable set top boxes and combinations thereof.

In addition, the DIRD 50 can be adapted to control two or more electronic devices, which can be the same devices (for example two televisions) or different devices, as shown in FIG. 3. Initially, the pillow speaker 20 would have controls to operate both electronic devices, for example a DVD and a television. As set forth above, the signal would be transmitted to corresponds to the first data signal generated by the pillow speaker 20 for a particular electrical device 12a, 12b, is transmitted through at least first and/or second operation wires 60a, 60b. The operation wires 60a, 60b each has a terminal end connected to a LED device 62a, 62b. The LED devices 62a, 62b operate with corresponding windows 14a, 14b of electronic devices 12a, 12b, in the same manner as the LED device 62 with the receiver window 14. That way, the pillow speaker 20 can control multiple, two or more, electronic devices at the same time.

Although a particular preferred embodiment of the invention has been illustrated and described in detail for illustrative purposes, it will be recognized that variations or modifications of the disclosed apparatus, including the rearrangement of parts, lie within the scope of the invention defined by the claims.

The embodiments of the invention in which an exclusive property or privilege is claimed are defined as follows:

We claim:

1. A hospital-ready electronic device comprising:
a non-hospital-ready electronic device having an infrared remote control system that receives an infrared signal through a window;
a pillow speaker that generates in response to a user's input a first data signal to alter the operation of the non-hospital-ready electronic device;
a data to infrared isolated interface device that (A) receives the first data signal, and (B) isolates the non-hospital-ready electronic device from the pillow speaker through a photodiode and a photosensitive transistor;
the photosensitive transistor generates a second data signal that corresponds to the first data signal and is generated in response to the first data signal contacting the photodiode;
an infrared emitter, positioned near the window, receives the second data signal and generates an infrared signal that corresponds to the second data signal and is transmitted into the window which allows the non-hospital-ready electronic device to be controlled by the user through the pillow speaker;
wherein the non-hospital-ready electronic device is converted into the hospital-ready electronic device.

2. The device of claim 1 wherein the non-hospital-ready electronic device is a television.

3. The device of claim 1 wherein the non-hospital-ready electronic device is a radio.

4. The device of claim 1 wherein the non-hospital-ready electronic device is a computer.

5. The device of claim 1 wherein the non-hospital-ready electronic device is a video game.

6. The device of claim 1 wherein the data to infrared isolated interface device receives an audio signal from the non-hospital-ready electronic device.

7. The device of claim 6 wherein the audio signal is isolated from the pillow speaker, and is transmitted to an audio wire that transmits the audio signal to the pillow speaker through a transformer isolator.

8. The device of claim 7 wherein the audio signal is directed to a speaker in the pillow speaker.

9. The device of claim 1 wherein the infrared emitter is attached to the non-hospital-ready electronic device and is over the window.

10. The device of claim 1 wherein the infrared emitter is within a container that is attached to the non-hospital-ready electronic device and is over the window.

11. The device of claim 1 wherein the infrared emitter is an LED device.

12. The device of claim 1 wherein the infrared emitter is within a container.

13. The device of claim 12 wherein the container decreases any inadvertent transmission of the infrared signal to anything other than through the window.

14. The device of claim 1 wherein the infrared emitter is optically isolated from the window.

15. The device of claim 1 wherein the altering the operation of the non-hospital-ready electronic device is selected from the group consisting of: adjusting the volume of the non-hospital-ready electronic device, adjusting a channel of the non-hospital-ready electronic device, adjusting a web site of the non-hospital-ready electronic device, adjusting an image of the nonhospital-ready electronic device, playing a video game on the non-hospital-ready electronic device, selecting a parameter on the web site of the non-hospital-ready electronic device, and turning the non-hospital-ready electronic device on or off.

16. A method of converting a non-hospital-ready electronic device having an infrared remote control system that receives an infrared signal through a window into a hospital-ready electronic device that uses a pillow speaker that generates in response to a user's input a first data signal to alter the operation of the non-hospital-ready electronic device comprising:
inserting a data to infrared isolated interface device between the non-hospital-ready electronic device and the pillow speaker, and the interface device (A) receives the first data signal, and (B) isolates the non-hospital-ready electronic device from the pillow speaker through a photodiode and a photosensitive transistor;
transmitting a second data signal from the photosensitive transistor, the second data signal corresponds to the first data signal and is generated in response to the first data signal contacting the photodiode;
generating an infrared signal from an infrared emitter when the second data signal contacts the infrared emitter, the infrared emitter is positioned near the window which allows the non-hospital-ready electronic device to be controlled by the user through the pillow speaker.

17. The method of claim 16 wherein the nonhospital-ready electronic device is a television.

18. The method of claim 16 wherein the nonhospital-ready electronic device is a radio.

19. The method of claim 16 wherein the nonhospital-ready electronic device is a computer.

20. The method of claim 16 wherein the nonhospital-ready electronic device is a video game.

21. The method of claim 16 wherein the data to infrared isolated interface device receives an audio signal from the non-hospital-ready electronic device.

22. The method of claim 21 wherein the audio signal is isolated from the pillow speaker, and is transmitted to an audio wire that transmits the audio signal to the pillow speaker through a transformer isolator.

23. The method of claim 22 wherein the audio signal is directed to a speaker in the pillow speaker.

24. The method of claim 16 wherein the infrared emitter is attached to the non-hospital-ready electronic device and is over the window.

25. The method of claim 16 wherein the infrared emitter is within a container that is attached to the non-hospital-ready electronic device and is over the window.

26. The method of claim 16 wherein the infrared emitter is an LED device.

27. The method of claim 16 wherein the infrared emitter is within a container.

28. The method of claim 27 wherein the container decreases any inadvertent transmission of the infrared signal to anything other than through the window.

29. The method of claim 16 wherein the infrared emitter is optically isolated from the window.

30. The method of claim 16 wherein the altering the operation of the non-hospital-ready electronic device is selected from the group consisting of: adjusting the volume of the non-hospital-ready electronic device, adjusting a channel of the nonhospital-ready electronic device, adjusting a web site of the non-hospital-ready electronic device, adjusting an image of the non-hospital-ready electronic device, playing a video game on the non-hospital-ready electronic device, selecting a parameter on the web site of the non-hospital-ready electronic device, and turning the non-hospital-ready electronic device on or off.

31. The method of claim 16 wherein the nonhospital-ready electronic device is selected from the group consisting of a television, a radio, a computer, a VCR, a DVD, a video game, a cable set top box, combinations thereof.

32. The method of claim 31 wherein the nonhospital-ready electronic device is at least two nonhospital-ready electronic devices;
wherein each of the two non-hospital electronic devices are selected from the group consisting of a television, a radio, a computer, a VCR, a DVD, a video game, a cable set top box, and wherein the each of the two non-hospital electronic devices can be the same or different.

33. The device of claim 1 wherein the nonhospital-ready electronic device is selected from the group consisting of a television, a radio, a computer, a VCR, a DVD, a video game, a cable set top box, combinations thereof.

32. The device of claim 33 wherein the nonhospital-ready electronic device is at least two nonhospital-ready electronic devices;
wherein each of the two non-hospital electronic devices are selected from the group consisting of a television, a radio, a computer, a VCR, a DVD, a video game, a cable set top box, and wherein the each of the two non-hospital electronic devices can be the same or different.
